(19) United States
(12) Patent Application Publication
(10) Pub. No.: US 2022/0339471 A1
(43) Pub. Date: Oct. 27, 2022

(54) MULTI-LAYER FILTRATION SYSTEM AND FILTER UNIT COMPRISING SAME

(71) Applicant: PINOSTORY CO., LTD., Seoul (KR)

(72) Inventor: Myung Won LEE, Seoul (KR)

(21) Appl. No.: 17/639,045

(22) PCT Filed: Aug. 26, 2020
(86) PCT No.: PCT/KR2020/011394

§ 371 Date: Feb. 28, 2022

(30) Foreign Application Priority Data
Aug. 27, 2019 (KR) 10-2019-0105368
Aug. 27, 2019 (KR) 10-2019-0105369

(51) Int. Cl. A62B 18/08; A62B 23/02; B01D 53/22; A62B 7/10; B01J 23/74; B01D 53/02; B01D 53/86; B01D 46/00; B01D 46/12; B01J 21/12; B01J 23/40; B01J 35/06; B01J 21/10; B01J 23/656; B01J 23/26; B01D 39/20

(52) U.S. Cl. CPC A62B 18/08; A62B 23/02; B01D 53/22; A62B 7/10; B01J 23/74; B01D 53/02; B01D 53/86; B01D 46/0035; B01D 46/0036; B01D 46/12; B01J 21/12; B01J 23/40; B01J 35/06; B01J 21/10; B01J 23/6562; B01J 23/26; B01D 39/2058; B01D 39/2031; B01D 39/2068; B01D 2257/93; B01D 2257/302; B01D 2257/304; B01D 2257/502; B01D 2257/404; B01D 2257/406; B01D 2257/708; B01D 2239/0428; B01D 2239/0407; B01D 2239/065

(57) ABSTRACT

Proposed is a multi-layer filtration system including a metal catalyst filter unit, a carbon filter unit, and an inorganic compound filter unit. The metal catalyst filter unit includes at least one among metals including Ni, Co, Fe, Cu, Cr, Mg, Zn, Ba, Au, Ag, Pd, Pt, Ru, Mn, and Ti, oxides thereof, and mixtures thereof. The carbon filter unit includes at least one of activated carbon or activated carbon fiber. The inorganic compound filter unit includes an inorganic compound capable of adsorbing toxic gas. The multi-layer filtration system has good removal effect for toxic gas. A filter module including the multi-layer filtration system and a gas mask including the multi-layer filtration system are also proposed.

### TECHNICAL FIELD

The present disclosure relates to a multi-layer filtration system for filtering gases that are polluted with toxic materials harmful to the human body. Specifically, the present disclosure relates to a multi-layer filtration system in which independent filter layers with added functionality are combined to increase the filtration efficiency of various toxic gases.

The disclosure also relates to a filter unit including the filtration system.

In addition, the present disclosure relates to a gas mask and the like manufactured using the filter unit.

### BACKGROUND ART

Background of the present disclosure is provided herein, and this does not necessarily imply known art.

Recently, due to the problem of air quality degradation, techniques for various filter structures have emerged. In addition, as one of the recent frequently occurring social issues, damage caused by toxic gas is reported when a fire occurs in a large building or the like. Although the time required to evacuate from such a fire situation is usually 3 to 5 minutes in many cases, there are many cases of asphyxiation by inhalation of carbon monoxide and toxic gas during evacuation. In fact, carbon monoxide is said to cause suffocation within two minutes of inhalation, and hydrogen cyanide gas (HCN) and sulfurous acid gas (SO₂), which are representative toxic gases generated in a fire site, are said to cause loss of consciousness even when people are exposed thereto for only a few tens of seconds.

In order to reduce such damage, a number of technologies related to a smoke mask have been disclosed. Korean Patent Application Patent No. 10-2018-0051295 discloses a fire evacuation rescue handkerchief in which an ampoule of herb extract is added to a handkerchief composed of microfiber fabric, charcoal fabric, and non-woven fabric. The ampoule of herb extract includes chamomile extract, calendula extract, sage extract, and the like, thereby giving a sedative effect to the human body. However, it is difficult to guarantee the effect of removing toxic gas and carbon monoxide only by soaking general smoke filters with an herbal extract. When the handkerchief is wet with the herb extract, the handkerchief can give the person calming effect, but the handkerchief itself does not act as a wet filter. Therefore, the functionality of the charcoal fabric that is partially wetted is lowered by the liquid contained in the herb extract, and the part that is not wetted acts as a general dry filter. Therefore, the handkerchief exhibits a low removal efficiency for toxic gas.

Korean Patent Application Publication No. 10-2015-0125905 discloses a technique for increasing the removal efficiency of a filter for toxic gas by supporting a metal catalyst on an activated carbon filter unit. In this case, since diverse types of catalysts need to be supported on activated carbon filter units to perform various functions, productivity in manufacturing the filters is low. In addition, the filter has a limit in actually removing toxic gases because the filter is partially dehumidified and treated to have water/oil repellency to prevent deterioration of the activated carbon performance.

Korea Patent No. 10-1738639 discloses a portable mask capable of purifying toxic gases. The patent document discloses that a wet filter retaining an adequate amount of moisture can be used to increase purification efficiency. However, the technology has the disadvantage of requiring vacuum packing to prevent moisture from escaping the wet filter.

### DISCLOSURE

### Technical Problem

Accordingly, one aspect of the present disclosure is to solve the above-described problems. The present disclosure provides a multi-layer filtration system capable of effectively removing toxic gases in usual times. Each filter included in the multi-layer filter system has a specific function to maximize filter efficiency.

In addition, the present disclosure provides a filter module including the multi-layer filtration system. The filter module may be used in a portable mask device for removing toxic gas or a gas mask purifier, and the present disclosure provides a mask device or gas mask.

The technical problems to be solved by the present disclosure are not limited to the ones mentioned above, and other technical problems which are not mentioned but can be solved by the present disclosure can be clearly understood by those skilled in the art from the following description.

### Technical Solution

According to one embodiment of the present disclosure, there is provided a multi-layer filtration system including a metal catalyst filter unit, a carbon filter unit, and an inorganic compound filter unit. In one embodiment, the metal catalyst filter unit may include a catalyst made from one or more metals selected from Ni, Co, Fe, Cu, Cr, Mg, Zn, Ba, Au, Ag, Pd, Pt, Ru, Mn, and Ti, from one or more oxides of the metals, or from a mixture thereof, and the carbon filter unit may include at least one of activated carbon and activated carbon fiber. Preferably, the metal catalyst may include Pt, Ru, Ag, or Au. In addition, examples of the mixed catalyst may include Fe—Cr—Al, 2MgO-2Al₂O₃-5SiO₂, and CuO—MnO₂. In the above embodiment, the multi-layer filtration system may further include at least one of a pre-filter unit and a HEPA filter unit.

According to another embodiment of the present disclosure, there is provided a multi-layer filtration system including a metal catalyst filter unit, a carbon filter unit, and an inorganic compound filter unit. In this embodiment, the metal catalyst filter unit includes at least one metal selected from Ni, Co, Fe, Cu, Cr, Mg, Zn, Ba, Au, Ag, Pd, Pt, Ru, Mn, and Ti, from one or more oxides thereof, or from a mixture thereof. The carbon filter unit includes at least one of activated carbon and activated carbon fiber. The inorganic compound filter unit includes a fiber base made from a woven or non-woven fabric containing at least one selected from natural fibers and synthetic fibers derived from cotton, rayon, lyocell, polyester, polypropylene, nylon, and mixtures of these, in which inorganic compounds such as chitosan, N-Halamine, hydroxyapatite, etc. may be incorporated in a manner that the inorganic compound is dispersed in the fabric base, or coated, laminated, or supported between fiber layers. In this case, the fiber base may be replaced with a microporous membrane substrate.

In the above embodiment, the multi-layer filtration system may further include at least one of a pre-filter unit and a HEPA filter unit.

According to a further embodiment of the present disclosure, there is provided a multi-layer filtration system including a metal catalyst filter unit, a carbon filter unit, an inorganic compound filter unit, and a wetting agent. The wetting agent may be in a form in which a liquid phase in an amount capable of implementing a wet filter in the multi-layer filter system is present in a sealing member. In addition, the liquid phase contained in the sealing member may be water (H₂O) alone and may further include an acid, alcohol, or diol represented by R—COOH, R—OH, or HO—R—OH in addition to water. In this case, the concentration of the acid, alcohol or diol may be 30% or less, and R is an alkyl group having 1 to 10 carbon atoms.

In the above embodiment, the multi-layer filtration system may be configured such that the pre-filter unit, the metal catalyst filter unit, the carbon filter unit, the inorganic compound filter unit, and the HEPA filter unit are stacked in this order in a direction in which the contaminated air is introduced. In this case, the sealing member containing the wetting agent may be located behind the inorganic compound filter unit or between the carbon filter unit and the inorganic compound filter unit.

According to a yet further embodiment of the present disclosure, there is provided a multi-layer filtration system including a metal catalyst filter unit, a carbon filter unit, an inorganic compound filter unit, and a wetting agent. In this embodiment, the metal catalyst filter unit includes a catalyst made from at least one metal selected from Ni, Co, Fe, Cu, Cr, Mg, Zn, Ba, Au, Ag, Pd, Pt, Ru, Mn, and Ti, from an oxide thereof, or from a mixture thereof. The carbon filter unit may include at least one of activated carbon and activated carbon fiber. The activated carbon or activated carbon fiber of the carbon filter unit may be stacked in the form of at least one layer, and a membrane may be provided at a boundary surface of the one or more activated carbon or activated carbon fiber layers. The membrane may be hydrophobic.

In the embodiment, the multi-layer filtration system may further include at least one of a pre-filter unit and a HEPA filter unit, and a hydrophobic membrane may be further included at an interface between the carbon filter unit and the adjacent filter thereof.

According to one embodiment of the present disclosure, there is provided a filter module including the multi-layer filtration system.

In the above embodiment, the filter module may further include a moisture barrier layer.

In addition, according to another embodiment of the present disclosure, there is provided a gas mask including the filter module.

According to a further embodiment of the present disclosure, there is provided a multi-layer filtration system including a metal catalyst filter unit, a carbon filter unit, and a wet variable filter unit. In the embodiment, the metal catalyst filter unit may include a catalyst made from one or more metals selected from Ni, Co, Fe, Cu, Cr, Mg, Zn, Ba, Au, Ag, Pd, Pt, Ru, Mn, and Ti, from an oxide thereof, or from a mixture of the metal(s) and the oxide(s), and the carbon filter unit may include at least one of activated carbon and activated carbon fiber. Preferably, the metal catalyst may include Pt, Ru, Ag, or Au. In addition, examples of the mixed catalyst may include Fe—Cr—Al, 2MgO-2Al₂O₃-5SiO₂, and CuO—MnO₂. In the above embodiment, the multi-layer filtration system may further include at least one of a pre-filter unit and a HEPA filter unit.

According to a further embodiment of the present disclosure, there is provided a multi-layer filtration system including a metal catalyst filter unit, a carbon filter unit, and a wet variable filter unit. In the above embodiment, the metal catalyst filter unit includes a catalyst made from one or more metals selected from Ni, Co, Fe, Cu, Cr, Mg, Zn, Ba, Au, Ag, Pd, Pt, Ru, Mn, and Ti, from one or more oxides thereof, or from any mixture thereof. The carbon filter unit may include at least one of activated carbon and activated carbon fiber. The wet variable filter unit may include a wettable member and a sealing member, and the wettable member may be a woven or unwoven fabric including one or more types of natural or synthetic fibers derived from cotton, rayon, lyocell, polyester, polypropylene, nylon or including any mixture thereof. In addition, the sealing member may be in the form of a pouch containing a liquid phase such as water or a liquid mixture containing at least 70% or more of water.

In the above embodiment, the multi-layer filtration system may further include at least one of a pre-filter unit and a HEPA filter unit. In addition, the liquid phase contained in the sealing member may further include chitosan, N-Halamine, and hydroxyapatite. In addition, the liquid phase in the sealing member may further include an acid, alcohol, or diol represented by R—COOH, R—OH, or HO—R—OH, in which the concentration of the acid, alcohol or diol may be 30% or less, and R may be an alkyl group having 1 to 10 carbon atoms.

In the above embodiment, the multi-layer filtration system may be configured such that the pre-filter unit, the metal catalyst filter unit, the carbon filter unit, the wet variable filter unit, and the HEPA filter unit are stacked in this order in a direction in which the contaminated air is introduced.

According to a further embodiment of the present disclosure, there is provided a multi-layer filtration system including a metal catalyst filter unit, a carbon filter unit, and a wet variable filter unit. In this embodiment, the metal catalyst filter unit may include a catalyst made from at least one metal selected from Ni, Co, Fe, Cu, Cr, Mg, Zn, Ba, Au, Ag, Pd, Pt, Ru, Mn, and Ti, from an oxide thereof, or from a mixture thereof. The carbon filter unit may include at least one of activated carbon and activated carbon fiber. The activated carbon or activated carbon fiber of the carbon filter unit may be stacked in the form of at least one layer, and a membrane may be provided at a boundary surface of the one or more activated carbon or activated carbon fiber layers. The membrane may be hydrophobic.

In the embodiment, the multi-layer filtration system may further include at least one of a pre-filter unit and a HEPA filter unit, and a hydrophobic membrane may be further included at an interface between the carbon filter unit and the adjacent filter thereof.

### Advantageous Effects

In some embodiments of the present disclosure, there is provided a multi-layer filtration in which multiple filters each of which can filter out carbon monoxide, SOₓ, NOR, H₂S, HCHO, NH₃, etc. are stacked, and there is also provided a filter module including the multi-layer filtration system. The filtration system and the filter module can effectively purify polluted harmful gases.

In other some embodiments of the present disclosure, there is provided a multi-layer filtration system in which several filters with respective functions are appropriately arranged, thereby being effective in purifying inhaled air during a fire event.

In other some embodiments of the present disclosure, there is provided a multi-layer filtration system manufactured by stacking filters capable of respectively filtering carbon monoxide, SOₓ, NOₓ, H₂S, HCHO, NH₃, etc. and there is also provided a filter module. The multi-layer filtration system and the filter module can effectively purify inhaled air.

On the other embodiments of the present disclosure, there is provided a multi-layer filtration system including a wet variable filter unit, thereby selectively using a wet filter, a dry filter, or both as necessary and effectively purifying inhaled air during a filter event.

### DESCRIPTION OF DRAWINGS

FIG. 1 is a schematic diagram illustrating the construction of a multi-layer filtration system according to one embodiment of the disclosure;

FIG. 2 is a schematic diagram illustrating the construction of a multi-layer filtration system according to another embodiment of the disclosure;

FIG. 3 is a schematic diagram illustrating the construction of a carbon filter unit according to one embodiment of the disclosure;

FIG. 4 is a schematic diagram illustrating the construction of a carbon filter unit according to another embodiment of the disclosure;

FIG. 5 is a schematic diagram illustrating the construction of an inorganic compound filter unit according to one embodiment of the disclosure;

FIG. 6 is a schematic diagram illustrating the construction of a portable gas mask according to one embodiment of the disclosure; and

FIG. 7 is a plan view illustrating a coupling protrusion in the portable gas mask manufactured by a manufacturing method according to one embodiment of the present disclosure.

### BEST MODE

Prior to a description of the present disclosure, it should be noted that the terms used in the present specification are used only to describe specific examples and are not intended to limit the scope of the present disclosure which will be defined only by the appended claims. Unless otherwise defined herein, all terms including technical and scientific terms used herein have the same meaning as commonly understood by those who are ordinarily skilled in the art to which this disclosure pertains.

Unless otherwise stated herein, it will be further understood that the terms “comprise”, “comprises”, and “comprising”, when used in this specification, specify the presence of stated features, regions, integers, steps, operations, elements and/or components but do not preclude the presence or addition of one or more other features, regions, integers, steps, operations, elements, components and/or groups thereof.

All or some embodiments described herein may be selectively combined and configured so that the embodiments may be modified in numerous ways unless the context clearly indicates otherwise. Features that are specifically advised to be desirable or preferable may be combined with any other features that are advised to be desirable or preferable.

Pre-Filter Unit

A pre-filter unit is a primary filter which the material to be filtered first comes into contact with when filtering or purifying polluted gas or liquid, and it is a kind of pre-treatment filter using a filter medium such as synthetic fiber or metal. When the pre-filter unit is used for general industrial purposes, the pre-filter unit refers to a filter that filters out dust having particle sizes of 10 μm or more.

A pre-filter that substantially constitutes the pre-filter unit used herein is made of, for example, a synthetic fiber nonwoven fabric. The nonwoven fabric may be manufactured through a spun bond method, a spun lace method, a needle punching method, a melt blown method, etc., and the raw material of the nonwoven fabric may be any one selected from nylon, polyester, polypropylene, polyethylene, and mixtures thereof.

In one embodiment of the present disclosure, the pre-filter unit is substantially made from a synthetic fiber nonwoven fabric. The synthetic fiber nonwoven fabric substantially constituting the pre-filter may have an average fiber diameter and an average pore diameter according to its use, and may have an appropriate filter thickness.

In one embodiment of the present disclosure, in a filter module used for a smoke mask, the pre-filter is a nonwoven fabric or a laminate of nonwoven fabric manufactured by a melt blown method using PET fibers containing 90% or more of polyethylene terephthalate (PET). The nonwoven fabric may have an average fiber diameter of 1 to 5 μm, and an average pore diameter of 5 to 10 μm. The nonwoven fabric may have a filling density of 0.1 g/100 ml to 1 g/100 ml so that the thickness of the filter is about 100 μm to 3 mm. The pre-filter may filter out fine dust (PM10) having particle sizes smaller than a particle size range that can be filtered out by a common pre-filter. That is, the pre-filter used in the embodiment can filter out fine dust (PM10) having sizes ranging from 2.5 μm to 10 μm.

Metal Catalyst Filter Unit

In one embodiment of the present disclosure, the metal catalyst filter unit may remove harmful gases such as carbon monoxide, SOₓ, and NOₓ when used for a gas mask, for example. In particular, the metal catalyst filter unit is effective in removing carbon monoxide. To remove carbon monoxide, the metal catalyst filter unit is configured such that a catalyst made from a metal or metal oxide on a metal or ceramic support having a large specific surface area. The material of the metal catalyst filter unit may be appropriately selected by those skilled in the art. Specifically, the material of the metal catalyst filter unit may be at least one metal selected from Ni, Co, Fe, Cu, Cr, Mg, Zn, Ba, Au, Ag, At, Pd, Pt, Ru, Mn, and Ti, or an oxide thereof, or a mixture thereof. Especially, noble metals such as Pt, Ru, Ag, and Au have been reported to exhibit catalytic activity for carbon monoxide. In addition, it has been reported that a Mn/Co/Ag composite oxide catalyst has high catalytic activity for the oxidation of CO and H₂ under the flow of CO and H₂. CuO also has been reported to exhibit good activity for the oxidation reaction of carbon monoxide.

According to an embodiment of the present disclosure, the key role of the metal catalyst filter unit is to oxidize and purify carbon monoxide. However, the type of the metal catalyst to be coated or supported may vary depending on the type of organic compounds to be decomposed, and the amount of the metal catalyst used may also vary depending on the use and required performance of the catalyst. In particular, when a metal catalyst having an antibacterial and sterilizing action, for example, Cu or Ag, is supported on a catalyst carrier, the storability of the filter can be improved.

In one embodiment of the present disclosure, the metal catalyst filter unit uses a catalyst contained in a carrier with a large specific surface area, such as zeolite or alumina. Alternatively, the metal catalyst may be mixed with a material including activated carbon, thereby being provided in any form such as beads, flakes, granules, or aggregates. The metal catalyst may be formed to have a structure having as large surface area as possible. For example, the metal catalyst may be formed to have honeycomb shape. The catalyst includes alumina and other metal oxides such as sodium bicarbonate, silver (Ag), nanoscale gold, Fe—Cr—Al, 2MgO-2Al₂O₃-5SiO₂, or CuO—MnO₂. When a mixed catalyst such as Fe—Cr—Al, 2MgO-2Al₂O₃-5SiO₂, or CuO—MnO₂ is used, the catalyst can be molded into spheres, pellets, or honeycombs with high compressive strength. In this case, the molded articles can be uses as a catalyst by being simply arranged in a form having a predetermined thickness rather than the molded articles are coated on a porous metal support.

Silver (Ag) particles, nanoscale gold, or a mixed catalyst (for example, Fe—Cr—Al, 2MgO-2Al₂O₃-5SiO₂, CuO—MnO₂) has excellent activity to catalyze the oxidation of carbon monoxide. Therefore, these materials can be preferably used as a catalyst of a metal catalyst filter unit of a smoke mask according to an embodiment of the present disclosure.

Carbon Filter Unit

In one embodiment of the present disclosure, the carbon filter unit may filter out harmful gases such as NOR, SOS, HCHO, H₂S, NH₃. The carbon filter unit may be manufactured using a carbon-based adsorbent capable of serving as an adsorbent. For example, the carbon filter unit may be manufactured using activated carbon or activated carbon fiber.

Activated carbon is used as an adsorbent in various industries due to its unique pore structure. Activated carbon has a unique pore structure and is used as an adsorbent in various industries. Activated carbon with micropores (2 nm or less) is used for gas or vapor adsorption, and activated carbon with mesopores (2 nm to 50 nm) is used to remove organic molecules from a liquid phase. Generally, activated carbon has a specific surface area of 1000 m²/g or less and a pore size of 10 to 104 Å. The limited specific surface area and wide pore distribution may act as disadvantages in terms of adsorption performance. Therefore, there are cases that activated carbon is treated with an oxidizing agent such as nitric acid or plasma in order to improve adsorption capacity of the activated carbon.

Activated carbon fiber is fibrous activated carbon, which is manufactured by firing and activating raw materials such as natural fibers, artificial organic substances, or chemical fibers. Activated carbon fiber is fibrous and contains many micropores on the surface of each fiber. Therefore, the activated carbon fiber has a large specific surface area. Generally, the surface area ranges from 500 to 3000 m²/g. In addition, since the diameter of the fiber is small, the fiber minimizes the material transfer resistance inside and outside. Therefore, the adsorption rate is fast. Accordingly, in one embodiment of the present disclosure, the carbon filter unit may be an activated carbon fiber filter containing 90% or more of activated carbon fibers. The activated carbon fibers used in one embodiment of the present disclosure have a diameter of about 5 to 20 m, and may have uniform pores in a range of 10 to 40 Å on the surface thereof. If necessary, the activated carbon fiber filter may include fibers such as cellulose acetate. In addition, a functional metal catalyst or the like may be coated or supported on the activated carbon fiber filter, depending on the use and required performance thereof. As a metal catalyst coated or supported on the activated carbon fiber, at least one metal selected from Ni, Co, Fe, Cu, Cr, Mg, Zn, Ba, Au, Ag, Pd, Pt, Ru, Mn, and Ti, or at least one oxide thereof, or a mixture thereof may be used. However, the type of the metal catalyst to be coated or supported may vary depending on the type of organic compounds to be decomposed, and the amount of the metal catalyst used may also vary depending on the use and required performance of the catalyst. In particular, when a metal catalyst having an antibacterial and sterilizing action, for example, Cu or Ag, is supported on a catalyst carrier, the storability of the filter can be improved.

The activated carbon fiber filter may be manufactured in the form of a woven fabric, a non-woven fabric, or a simple short fiber aggregate. Activated carbon fiber nonwoven fabric can be produced by carbonizing and activating nonwoven fabric after processing phenolic fibers into nonwoven fabric using a conventional nonwoven fabric manufacturing method. For example, a phenol-based nonwoven fabric manufacturing method is disclosed in Korean Patent No. 10-1891377. The ordinarily skilled in the art can set an appropriate thickness for a nonwoven fabric of activated carbon fibers or an aggregate of activated carbon fibers, depending on filtration efficiency and pressure loss.

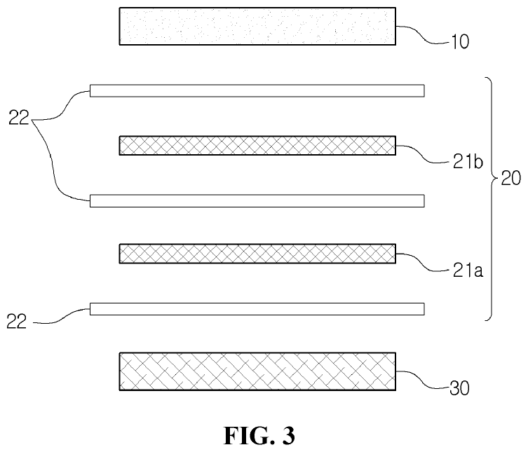

In one embodiment of the present disclosure, the carbon filter unit has at least one or more activated carbon or activated carbon fiber filter layers. In one embodiment of the present disclosure, the carbon filter unit may include a plurality of activated carbon or activated carbon fiber filter layers and a membrane disposed between each of the plurality of filter layers. As illustrated in FIG. 3, when the carbon filter unit includes two activated carbon fiber filter layers, a membrane 22 is interposed between a first activated carbon fiber filter 21a and a second activated carbon fiber filter 21b. When an inorganic compound filter unit 30 is wet, the membrane 22 may block moisture so that the moisture does not impair the adsorption performance of the carbon filter unit 20. To enhance the moisture barrier effect, the membrane 22 may be hydrophobic.

In one embodiment of the present disclosure, the membrane 22 is formed not only between the activated carbon fiber filters, but also between the inorganic compound filter unit and the carbon filter unit and/or. That is, the membrane 22 may be disposed between the carbon filter unit and the adjacent filter unit (for example, metal catalyst filter unit 10).

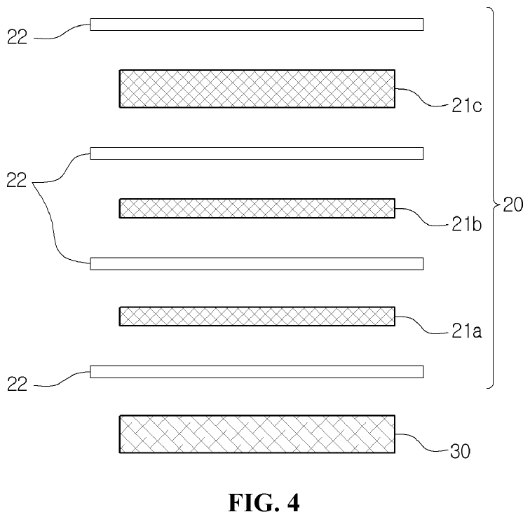

In another embodiment of the present disclosure, the thickness of each of the plurality of activated carbon or activated carbon fiber filter layers may be the same or different. For example, the thickness of the activated carbon or activated carbon fiber filter layer adjacent to the inorganic compound filter unit may be smaller than the thickness of the other activated carbon or activated carbon fiber filter layers. Referring to FIG. 4, in one embodiment of the present disclosure, the carbon filter unit includes three activated carbon fiber filters. In this case, a first activated carbon fiber filter 21a and a second active carbon fiber filter 21b both of which are adjacent to the inorganic compound filter unit may have a thickness of 1 mm, and a third activated carbon fiber filter 21c stacked that adjacent to the inorganic compound filter may have a thickness of 3 mm. The activated carbon fiber filter may include activated carbon fibers having the same or different pore diameters and the same or different fiber diameters.

Inorganic Compound Filter

Inorganic compounds such as chitosan, N-Halamine, and hydroxyapatite may be present in the inorganic compound filter unit according to an embodiment of the present disclosure. In particular, hydroxyapatite is a calcium phosphate-based ceramic, and as a main component of human bones. hydroxyapatite has excellent bone conductivity, bioactivity, and biocompatibility. In addition, hydroxyapatite, which has a structure in which calcium ions and phosphate groups are regularly arranged at high density, is a zwitterion exchanger and has an adsorption function according to electrostatic interaction, thereby exhibiting excellent protein adsorption, heavy metal adsorption, and antibacterial and antiviral properties. The chemical formula of hydroxyapatite is Ca₁₀(PO₄)₆OH₂, and is used for liquid chromatography and water treatment filter due to high protein adsorption performance thereof.

The inorganic compound filter unit is configured such that a woven fabric or non-woven fabric containing at least one type of fiber selected from natural fibers and synthetic fibers which are derived from cotton, rayon, lyocell, polyester, polypropylene, nylon, etc., or containing a mixture thereof serves as a base member, and inorganic compounds such as chitosan, N-Halamine, hydroxyapatite, etc. are incorporated in the base member. Specifically, the inorganic compounds are dispersed in, coated on, or stacked between fiber layers.

In one embodiment of the present disclosure, chitosan, N-Halamine or hydroxyapatite, which are inorganic compounds included in the inorganic compound filter unit, may be supported on the fiber-based base member. In this case, the inorganic compound may be included in an amount of 5% to 85% by weight with respect to the total weight of the woven fabric or nonwoven fabric. Detailed information on a fiber adsorbent supporting hydroxyapatite, which is one of the inorganic compounds that can be used in the present disclosure, is disclosed in Korean Patent No. 10-1521991.

In one embodiment of the present disclosure, the fiber-based base member may be derived from cotton, rayon, lyocell, etc., which are cellulosic fibers. Cellulose-derived fibers are hydrophilic. Therefore, when the wetting agent to be described below is included in the multi-layer filtration system, the filtration system can maximize the toxic gas removal efficiency. Synthetic fibers derived from polyester, polypropylene, nylon, etc. may also be used as a raw material for the fiber-based base member, and, if necessary, the synthetic fibers may be subjected to moisture affinity treatment to increase wettability.

In one embodiment of the present disclosure, the base member of the inorganic compound filter unit may be a microporous membrane. The microporous membrane has a structure that can contain an inorganic compound like the fiber-based base member and may be made of a polymer material or a ceramic material to secure moldability and stability of physical properties. As the polymer material, both a thermoplastic resin and a thermosetting resin can be used, but a thermoplastic resin advantageous for molding is preferable. Examples of the polymer resin include Polyether sulfone, polyvinylidene chloride, polyethylene terephthalate, polylactic acid, polyethylene, polypropylene, polycarbonate, polymethyl methacrylate, polyvinyl chloride, polyurethane, polyamide, cellulose, silicone resin, and epoxy resin. Examples of the ceramic material include silica, alumina, aluminum nitride, and silicon carbide.

The inorganic compound included in the inorganic compound filter unit may be coated or supported while it is in a powder form. The smaller the particle size of the powder, the more advantageous in terms of adsorption performance. However, the inorganic compound preferably has sizes in the range of 0.3 μm to 3 μm not to affect the human body when the wearer of the filter system breathes in the inorganic compound while deteriorating the expected effect thereof

Wetting Agent

According to one embodiment of the present disclosure, the multi-layer filtration system may include a wetting agent. The wetting agent may serve to dissolve toxic gas generated during a fire so as not to affect the human body when the use of the embodiment of the present disclosure is a gas mask that can be used in case of fire. In the event of a fire in a building, most household tools, textiles, and interior materials made of petrochemical materials undergo incomplete combustion, releasing carbon monoxide and other toxic gases. Since these toxic gases are synthetic toxic gases containing various compounds, the toxic gases may irritate the respiratory tract or eyes, and even cause neurological and cognitive dysfunction, leading to death.

A filter module according to an embodiment of the present disclosure may include a wetting agent for preventing inhalation of toxic gas emitted during a fire. The wetting agent may include a liquid phase such as water or a liquid mixture containing water as a main component. Water as a main component may mean that the concentration of water in the liquid phase is 70% or more. The liquid phase included in the wetting agent may be present, for example, in a pouch-type sealing member in the packaging state before the smoke mask is actually used. In a fire event in which a smoke mask is used, the sealing member is broken or cut by physical force or pressure, and the liquid phase is discharged to the outside of the sealing member, thereby wetting the adjacent filter unit. In the event of a fire, the liquid is ejected, thereby giving an effect that the user covers the nose with a wet towel to protect the respiratory system and to prevent inhalation of toxic gas.

The liquid phase contained in the sealing member in one embodiment of the present disclosure may further include an acid, alcohol, or diol, which can be expressed by the formula “R—COOH”, “R—OH”, or “HO—R—OH”. When the acid, alcohol or diol is included, since carbon monoxide has a property of being dissolved in an aqueous solution containing alcohol, the effect of removing the carbon monoxide can be further enhanced. In the above formula, R may be an alkyl group having 1 to 10 carbon atoms.

In one embodiment of the present disclosure, when an acid, alcohol or diol component is included in the liquid phase contained in the sealing member, the concentration of the acid, alcohol or diol component may be 5 to 25%. When the concentration of the component is 5% or less, carbon monoxide adsorption performance may be low. When the concentration of the component is 25% or more, storage stability may be low.

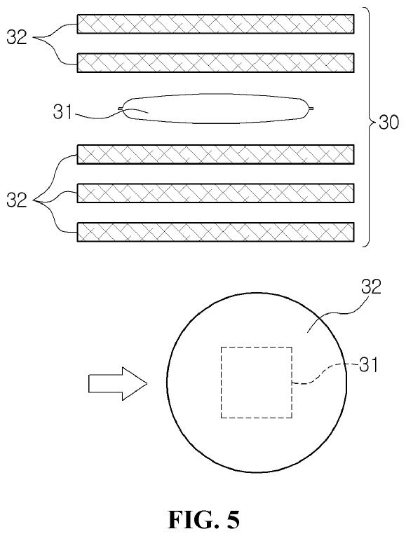

As illustrated in FIG. 5, the sealing member 31 containing the liquid phase is located in the inorganic compound filter unit composed of a plurality of layers. The sealing member 31 containing the liquid phase may be located between the plurality of inorganic compound filters 32 or may be located between the inorganic compound filter unit and the adjacent filter unit. In addition, the sealing member 31 containing the liquid phase may have an appropriate size or may be disposed at an appropriate location so that gas can pass through the wettable member even in a non-broken/incised state.

In one embodiment of the present disclosure, the sealing member containing the liquid phase is located between a plurality of inorganic compound filters. The sealing member is disposed such that a breaking or tearing member can break or tear the sealing member.

The inorganic compound filter 32 may be made of woven or non-woven fabric, and various fibers including natural fibers to chemical fibers can be used. Cellulose-based fibers such as cotton, rayon, and lyocell have hydrophilic properties and thus may be preferably used. Synthetic fibers derived from polyester, polypropylene, nylon, etc. may also be used, and, if necessary, the synthetic fibers may be subjected to moisture affinity treatment so that the synthetic fibers have increased wettability.

HEPA Filter Unit

In one embodiment of the present disclosure, the HEPA filter unit is composed of a HEPA filter. A HEPA filter is a type of high-efficiency air filter. In order to meet the standards prescribed by the U.S. Department of Energy, it is necessary to remove 99.97% or more of particles having sizes of 0.3 μm or larger. In general, a HEPA filter is an aggregate of irregularly arranged fibers. The fiber may be a glass fiber or a synthetic fiber, and the diameter of the fiber may be 0.5 to 2.0 μm. A key factor in the function of a HEPA filter is the diameter of the fiber and the thickness of the filter. The fiber pore size of the HEPA filter exceeds 0.3 μm. This is because the HEPA filter does not simply act as a sieve that prevents the particles to be filtered from passing through the fiber pores. In the process of particle collection in the HEPA filter, the mechanisms of inertial impaction, diffusion, interference, and electrostatic attraction act in a complicated way.

In one embodiment of the present disclosure, the HEPA filter of the HEPA filter unit may be made of synthetic fibers, and the synthetic fibers include polyethylene, nylon, polystyrene, and the like. In one embodiment of the present disclosure, the synthetic fiber of the HEPA filter unit may be made from polystyrene.

Multi-Layer Filtration System-1

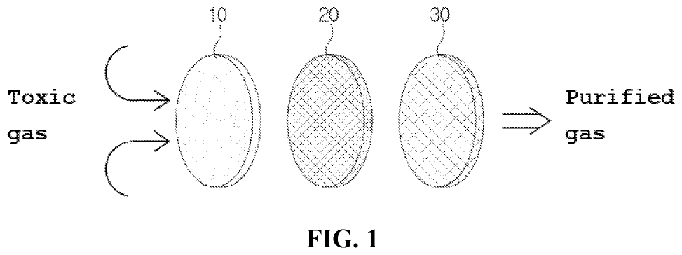

In one embodiment of the present disclosure, the multi-layer filtration system is configured such that a metal catalyst filter unit, a carbon filter unit, and an inorganic compound filter unit are stacked. The multi-layered system according to an embodiment of the present disclosure may be used as a multilayer filtration system included in a filter module for filtering out harmful gases such as CO, NOR, SOS, HCHO, NH₃, H2S, and the like. In the multi-layer filtration system, as illustrated in FIG. 1, the metal catalyst filter unit 10 is located on the side where the metal catalyst filter unit 10 first meets the harmful gas, and then the carbon filter unit 20 and the inorganic compound filter unit 30 are located behind the metal catalyst filter unit in the inflow direction. The carbon filter unit may be a filter using activated carbon or activated carbon fiber. A metal catalyst having adsorption function may be selectively supported on the carbon filter unit regardless of the presence or absence of the metal catalyst filter unit. When the metal catalyst is supported on the carbon filter unit, the same or different catalyst as that present in the metal catalyst filter unit may be supported.

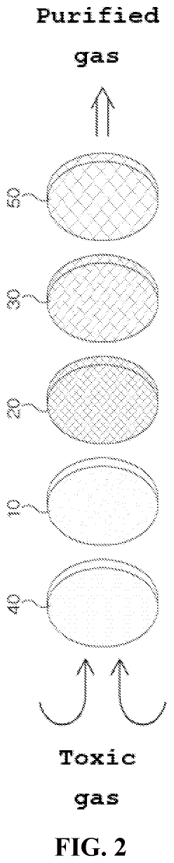

In another embodiment of the present disclosure, a multi-layer filtration system may include a pre-filter unit, a metal catalyst filter unit, a carbon filter unit, and an inorganic compound filter unit. The multi-layer filtration system may further include a HEPA filter unit if necessary. The pre-filter unit may primarily filter large particles of dust and the like and may protect the filter units arranged behind the pre-filter unit. The HEPA filter unit may filter activated carbon particles, metal catalyst particles, hydroxyapatite particles, and the like, which may be generated due to the characteristics of the internal structure of the multi-layer filtration system. The HEPA filter unit may filter out particles having a particle size of 0.3 μm or more contained in the contaminated gas. In the multi-layer filtration system according to one embodiment of the present disclosure, as illustrated in FIG. 2, the pre-filter unit 40 is located on the side where polluted gas is introduced, and the metal catalyst filter unit 10—, the carbon filter unit 20, and the inorganic compound filter unit 30 are located behind the pre-filter unit in the inflow direction. The carbon filter unit may be a filter using activated carbon or activated carbon fiber. A metal catalyst having adsorption function may be selectively supported on the carbon filter unit regardless of the presence or absence of the metal catalyst filter unit. When the metal catalyst is supported on the carbon filter unit, the same or different catalyst as that present in the metal catalyst filter unit may be supported.

As illustrated in FIG. 3, the carbon filter unit 20 includes one or more layers made from activated carbon or activated carbon fiber. In one embodiment of the present disclosure, the carbon filter unit may include a plurality of activated carbon or activated carbon fiber filter layers and a membrane disposed between each of the plurality of filter layers. As illustrated in FIG. 3, when the carbon filter unit includes two activated carbon fiber filter layers, a membrane 22 is interposed between a first activated carbon fiber filter 21a and a second activated carbon fiber filter 21b. When the inorganic compound filter unit 30 is wet, the membrane 22 may block moisture so that the moisture does not impair the adsorption performance of the carbon filter unit 20. To enhance the moisture barrier effect, the membrane 22 may be hydrophobic.

In one embodiment of the present disclosure, the membrane 22 is formed not only between the activated carbon fiber filters, but also between the inorganic compound filter unit and the carbon filter unit and/or. That is, the membrane 22 may be disposed between the carbon filter unit and the adjacent filter unit (for example, metal catalyst filter unit 10).

In one embodiment of the present disclosure, the membrane may be used as a packaging member for supporting the main component in each filter unit.

As illustrated in FIG. 5, the sealing member containing the liquid phase may be located in the inorganic compound filter unit 30 composed of a plurality of inorganic compound layers. The sealing member 31 containing the liquid phase is positioned between each of the plurality of inorganic compound filters 32. In addition, the sealing member 32 containing the liquid phase may have an appropriate size or may be disposed at an appropriate location so that gas can pass through the wettable member even in a non-broken/incised state.

Filter Module-1

A filter module according to an embodiment of the present disclosure is a filter module including the multi-layer filtration system. The filter module according to an embodiment of the present disclosure is structured such that the pre-filter unit, the metal catalyst filter unit, the carbon filter unit, the inorganic compound filter unit, and the HEPA filter unit are stacked and is processed to be mounted on a ventilation mask or a gas mask that is a product to be marketed.

In addition to the filter units, the filter module may further include an anti-fouling member capable of preventing external moisture or contaminants from entering the filter system so that the multi-layer filtration system can be stably stored for a long time. As the anti-fouling material, any material can be used without limitation if it is a material capable of protecting the multi-layer filtration system from external contaminants. Preferably, as the anti-fouling material, a material that can block moisture is used to prevent deterioration in the performance of oxidizing or adsorbing toxic gas In one embodiment of the present disclosure, the anti-fouling material may be a composite sheet in which a metal such as aluminum is deposited on a film made of polyethylene terephthalate (PET), polypropylene (PP), or polystyrene.

Wet Variable Filter

In a multi-layer filtration system according to another embodiment of the present disclosure, the inorganic compound filter unit in the structure of the multi-layer filtration system of the previous embodiment is replaced by a wet variable filter unit.

In the following description, the wet variable filter unit is described in such a way that the reference numeral and a part of the structure of the inorganic compound filter unit are used as they are. Accordingly, there may be differences between the description of the inorganic compound filter unit and the description of the wet variable filter unit although the same reference numerals are used, which will be clearly understood by those skilled in the art from the following description.

The wet variable filter unit may serve to remove toxic gas generated during a fire event when the use of the embodiment of the present disclosure is a gas mask that can be used in case of fire. In the event of a fire in a building, most household tools, textiles, and interior materials made of petrochemical materials undergo incomplete combustion, releasing carbon monoxide and other toxic gases. Since these toxic gases are synthetic toxic gases containing various compounds, the toxic gases may irritate the respiratory tract or eyes, and even cause neurological and cognitive dysfunction, leading to death.

The filter module according to an embodiment of the present disclosure is provided with a wet variable filter unit for preventing the wearer from breathing in toxic gas generated during a fire event, and the wet variable filter contains liquid water or a liquid mixture containing water as a main ingredient. Water as a main ingredient may mean that the concentration of water in the liquid mixture is 70% or more. The liquid phase contained in the wet variable filter may be present, for example, in a pouch-type sealing member in a packaging state before the smoke mask is actually used. In a fire situation in which the smoke mask is used, liquid is ejected from the sealing member because the sealing member is broken or torn due to physical force or pressure applied thereto, so that the wet variable filter unit can be converted from a dry state to a wet state. About 90% or more portion of the wet variable filter is converted from the wet state. In the event of a fire, the liquid is ejected, thereby giving an effect that the user covers the nose with a wet towel to protect the respiratory system and to prevent inhalation of toxic gas.

A liquid phase including chitosan, N-Halamine, and hydroxyapatite may be present in the wet variable filter unit according to an embodiment of the present disclosure. In particular, hydroxyapatite is a calcium phosphate-based ceramic, and as a main component of human bones. hydroxyapatite has excellent bone conductivity, bioactivity, and biocompatibility. In addition, hydroxyapatite, which has a structure in which calcium ions and phosphate groups are regularly arranged at high density, is a zwitterion exchanger and has an adsorption function according to electrostatic interaction, thereby exhibiting excellent protein adsorption, heavy metal adsorption, and antibacterial and antiviral properties. The chemical formula of hydroxyapatite is Ca₁₀(PO₄)₆OH₂ and is used for liquid chromatography and water treatment filter due to high protein adsorption performance thereof.

In one embodiment of the present disclosure, the liquid phase in the sealing member in the wet variable filter unit may include a dispersion of hydroxyapatite powder having an average particle size of 1 to 10 μm mixed with distilled water in a mass ratio of 1:1. The dispersion may be further pulverized using an abrasive grinder or the like to improve performance. As the hydroxyapatite is pulverized to a smaller size, the adsorption performance may be improved. However, the particle size of the hydroxyapatite powder contained in the liquid phase according to an embodiment of the present disclosure may be 0.3 μm to 3 μm not to affect the human body when the wearer of the gas mask breaths in the powder.

The liquid phase contained in the sealing member in one embodiment of the present disclosure may further include an acid, alcohol, or diol which can be expressed by the formula “R—COOH”, “R—OH”, or “HO—R—OH”. When the acid, alcohol or diol is included, since carbon monoxide has a property of being dissolved in an aqueous solution containing alcohol, the effect of removing the carbon monoxide can be further enhanced. In the above formula, R may be an alkyl group having 1 to 10 carbon atoms.

In one embodiment of the present disclosure, when an acid, alcohol or diol component is included in the liquid phase contained in the sealing member, the concentration of the acid, alcohol or diol component may be 5 to 25%. When the concentration of the component is 5% or less, carbon monoxide adsorption performance may be low. When the concentration of the component is 25% or more, storage stability may be low.

As illustrated in FIG. 5, the sealing member 31 containing the liquid phase is located in a wet variable layer including a plurality of wettable members. The sealing member 31 containing the liquid phase may be located between each of the plurality of wettable members 32 or may be located between the wet variable filter unit and the adjacent filter unit. In addition, the sealing member 31 containing the liquid phase may have an appropriate size or may be disposed at an appropriate location so that gas can pass through the wettable member even in a non-broken/incised state of the sealing member.

In one embodiment of the present disclosure, the sealing member containing the liquid phase is located between the plurality of wettable members. The sealing member is disposed such that a breaking or tearing member can break or tear the sealing member.

The wettable member 32 may be made of woven or non-woven fabric, and various fibers including natural fibers to chemical fibers can be used. Cellulose-based fibers such as cotton, rayon, and lyocell are hydrophilic. Therefore, such fibers may be preferably used as the wettable member 32. Synthetic fibers derived from polyester, polypropylene, nylon, etc. may also be used as a material for the wettable member 32. If necessary, the synthetic fibers may be subjected to moisture affinity treatment so that the synthetic fibers have increased wettability.

In one embodiment of the present disclosure, chitosan, N-Halamine, or hydroxyapatite may be supported on the wettable member of the wet variable filter unit. In this case, the wettable member may be in the form of a woven or nonwoven fabric, and the hydroxyapatite may be included in an amount of 5% to 85% by weight with respect to the total weight of the woven or nonwoven fabric. Detailed information on a fiber adsorbent supporting hydroxyapatite is disclosed in Korean Patent No. 10-1521991.

Multi-Layer Filtration System-2

In one embodiment of the present disclosure, a multi-layer filtration system is configured such that a metal catalyst filter unit, a carbon filter unit, and a wet variable filter unit are stacked.

In the multi-layer filtration system, the inorganic compound filter unit of the multi-layer filtration system-1 is replaced with the wet variable filter unit, and the other elements are the same. Accordingly, the illustration in the drawings and reference numerals used in the description below share the configuration and reference numerals used in the description of the multi-layer filtration system-1 except for some reference numerals used to describe the wet variable filter.

The multi-layered system according to an embodiment of the present disclosure may be used as a multilayer filtration system included in a filter module for filtering out harmful gases such as CO, NOₓ, SOₓ, HCHO, NH₃, H₂S, and the like. In the multi-layer filtration system, as illustrated in FIG. 1, the metal catalyst filter unit 10 is located on the side where the metal catalyst filter unit 10 first meets harmful gas, and then the carbon filter unit 20 and the wet variable filter unit 30 are located behind the metal catalyst filter unit in the inflow direction. The carbon filter unit may be a filter using activated carbon or activated carbon fiber. A metal catalyst having adsorption function may be selectively supported on the carbon filter unit regardless of the presence or absence of the metal catalyst filter unit. When the metal catalyst is supported on the carbon filter unit, the same or different catalyst as that present in the metal catalyst filter unit may be supported.

In another embodiment of the present disclosure, a multi-layer filtration system may include a pre-filter unit, a metal catalyst filter unit, a carbon filter unit, and a wet variable filter unit. The multi-layer filtration system may further include a HEPA filter unit if necessary. The pre-filter unit may primarily filter large particles of dust and the like and may protect the filter units arranged behind the pre-filter unit. The HEPA filter unit may filter activated carbon particles, metal catalyst particles, hydroxyapatite particles, and the like, which may be generated due to the characteristics of the internal structure of the multi-layer filtration system. The HEPA filter unit may filter out particles having a particle size of 0.3 μm or more contained in the contaminated gas. In the multi-layer filtration system according to one embodiment of the present disclosure, as illustrated in FIG. 2, the pre-filter unit 40 is located on the side where polluted gas is introduced, and the metal catalyst filter unit 10-, the carbon filter unit 20, and the wet variable filter unit 30 are located behind the pre-filter unit in the inflow direction. The carbon filter unit may be a filter using activated carbon or activated carbon fiber. A metal catalyst having adsorption function may be selectively supported on the carbon filter unit regardless of the presence or absence of the metal catalyst filter unit. When the metal catalyst is supported on the carbon filter unit, the same or different catalyst as that present in the metal catalyst filter unit may be supported.

As illustrated in FIG. 3, the carbon filter unit 20 includes one or more layers made from activated carbon or activated carbon fiber. In one embodiment of the present disclosure, the carbon filter unit may include a plurality of activated carbon or activated carbon fiber filter layers and a membrane disposed between each of the plurality of filter layers. As illustrated in FIG. 3, when the carbon filter unit includes two activated carbon fiber filter layers, a membrane 22 is interposed between a first activated carbon fiber filter 21a and a second activated carbon fiber filter 21b. When the wet variable filter unit 30 is converted from a dry state to a wet state, the membrane 22 may block moisture so that the moisture does not impair the adsorption performance of the carbon filter unit 20. To enhance the moisture barrier effect, the membrane 22 may be hydrophobic.

In one embodiment of the present disclosure, the membrane 22 is formed not only between the activated carbon fiber filters, but also between the wet variable filter unit and the carbon filter unit. That is, the membrane 22 may be disposed between the carbon filter unit and the adjacent filter unit (for example, metal catalyst filter unit 10).

In one embodiment of the present disclosure, the membrane may be used as a packaging member for supporting the main component in each filter unit.

As illustrated in FIG. 5, the sealing member containing the liquid phase is located in a wet variable layer including a plurality of wettable layers. The sealing member 31 containing the liquid phase is positioned between each of the plurality of wettable members 32. In addition, the sealing member 32 containing the liquid phase may have an appropriate size or may be disposed at an appropriate location so that gas can pass through the wettable member even in a non-broken/incised state of the sealing member.

Filter Module-2

A filter module according to an embodiment of the present disclosure is a filter module including the multi-layer filtration system. The filter module according to an embodiment of the present disclosure is structured such that the pre-filter unit, the metal catalyst filter unit, the carbon filter unit, the wet variable filter unit, and the HEPA filter unit are stacked and is processed to be mounted on a ventilation mask or a gas mask that is a product to be marketed.

In addition to the filter units, the filter module may further include an anti-fouling member capable of preventing external moisture or contaminants from entering the filter system so that the multi-layer filtration system can be stably stored for a long time. As the anti-fouling material, any material can be used without limitation if it is a material capable of protecting the multi-layer filtration system from external contaminants. Preferably, as the anti-fouling material, a material that can block moisture is used to prevent deterioration in the performance of oxidizing or adsorbing toxic gas In one embodiment of the present disclosure, the anti-fouling material may be a composite sheet in which a metal such as aluminum is deposited on a film made of polyethylene terephthalate (PET), polypropylene (PP), or polystyrene.

Moisture Barrier Layer

The filter modules according to embodiments of the present disclosure may include a moisture barrier layer. The moisture barrier layer together with the anti-fouling material or moisture blocking material may block moisture that may be introduced from the outside. The moisture barrier layer may be arbitrarily disposed in the stacked structure of various filter units constituting the filter module. In terms of blocking external moisture, the multi-layer filtration system in the filter module may be located before and after the pre-filter unit or the HEPA filter unit which is the outermost layer.

The type of desiccant that can be used is not particularly limited. For example, silica gel, calcium chloride, zeolite, or a super absorbent resin may be used for the moisture bather layer.

The thickness of the moisture barrier layer is also not particularly limited but may be in a range of 1 mm to 10 mm in terms of securing moisture-proof performance while minimizing the influence on the performance and thickness of the filter module.

### Mode for Carrying out the Disclosure

Manufacturing Example—Portable Gas Mask

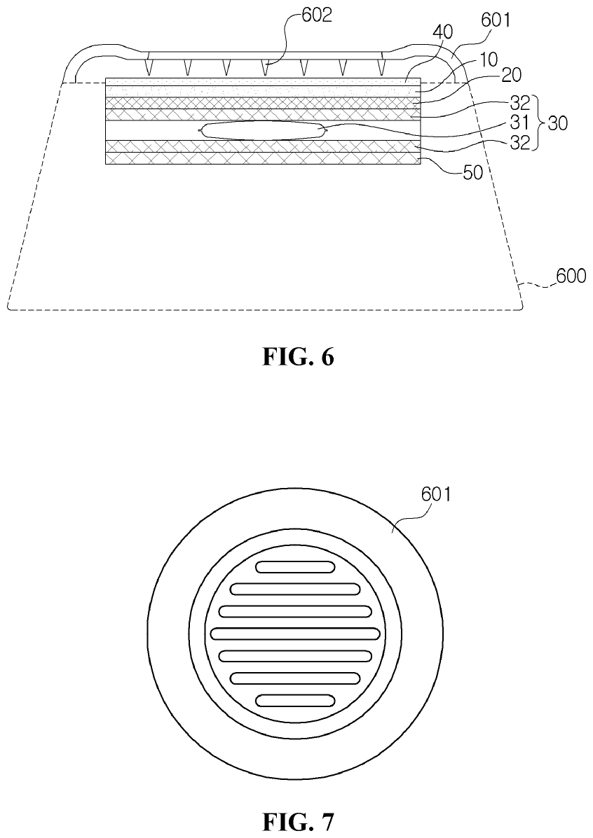

A portable gas mask was manufactured using the filter module according to one embodiment of the present disclosure. The portable gas mask may be manufactured in a size that is easy to carry all the time. Regarding the portable gas mask in this manufacturing example, refer to Korean Patent Application Publication No. 10-2019-0012174 (Jan. 30, 2019) in its entirety. The filter module may be mounted in a cylindrical shape in a portable gas mask. As schematically illustrated in FIG. 6, a portable gas mask body 600 is provided in a truncated cone shape so that a portion having a wide cross-section can be in close contact with the respiratory system of the human body. The gas mask may include a coupling member 601 to prevent removal of the filter module from the suction side of harmful gas, and the coupling member 601 may include a protrusion 602. The coupling member 601 is made of a flexible member that can move in the direction of pressure when a certain pressure is applied. When pressure is applied to a portion where the protrusion 602 is present, the sealing member 31 containing the liquid phase can be broken. Therefore, when the sealing member 31 is not broken, the filter module can be used as a dry filter. The filter module can be used as a dry and wet hybrid filter by intentionally breaking the sealing member 31 to increase the toxic gas removal effect.

A composite sheet 60 for preventing the filter module from being contaminated may be attached to the coupling protrusion to block an intake port. In addition, the composite sheet 60 may be attached to the HEPA filter unit that is to be closest to the human body when the gas mask is worn.

### EXPLANATION OF REFERENCE NUMERALS IN THE DRAWINGS

10: Metal catalyst filter unit
20: Carbon filter unit
30: Inorganic compound filter unit or wet variable filter unit
31: Wetting agent
40: Pre-filter unit
50: HEPA filter unit
60: Composite sheet
600: Gas mask body
601: Coupling member

### INDUSTRIAL APPLICABILITY

The multi-layer filtration system according to the present disclosure can be manufactured as a filter module that can be used for filtration of polluted gases or liquids. The filter unit may be used in a ventilation mask device or a gas mask purifier.

1. A multi-layer filtration system comprising: a metal catalyst filter unit; a carbon filter unit; and an inorganic compound filter unit, wherein the metal catalyst filter unit comprises at least one among metals including Ni, Co, Fe, Cu, Cr, Mg, Zn, Ba, Au, Ag, Pd, Pt, Ru, Mn, and Ti, oxides thereof, and mixtures thereof, the carbon filter unit comprises at least one of activated carbon or activated carbon fiber, and the inorganic compound filter unit comprises an inorganic compound incorporated in a fiber base member or a microporous membrane.

2. The multi-layer filtration system of claim 1, further comprising a pre-filter, a HEPA filter, or both.

3. The multi-layer filtration system of claim 1, further comprising a wetting agent, wherein the wetting agent comprises water or a liquid mixture containing 70% or more of water.

4. The multi-layer filtration system of claim 3, further comprising a pre-filter, a HEPA filter, or both.

5. The multi-layer filtration system of claim 3, wherein the wetting agent is contained in a sealing member.

6. The multi-layer filtration system of claim 3, wherein the wetting agent further comprises acid, alcohol, or diol represented by R—COOH, R—OH, or HO—R—OH, wherein the concentration of the acid, alcohol, or diol is 50% or less, wherein R is an alkyl group having 1 to 10 carbon atoms.

7. The multi-layer filtration system of claim 5, wherein the wetting agent contained in the sealing member further comprises acid, alcohol, or diol represented by R—COOH, R—OH, or HO—R—OH, wherein the concentration of the acid, alcohol, or diol is 50% or less. wherein R is an alkyl group having 1 to 10 carbon atoms.

8. The multi-layer filtration system of claim 4, wherein the pre-filter unit, the metal catalyst filter unit, the carbon filter unit, the inorganic compound filter unit, and the HEPA filter unit are stacked in this order in a direction in which contaminated air is introduced.

9. A multi-layer filtration system comprising: a metal catalyst filter unit; a carbon filter unit; and an inorganic compound filter unit, wherein the metal catalyst filter unit comprises at least one among metals selected from Ni, Co, Fe, Cu, Cr, Mg, Zn, Ba, Au, Ag, Pd, Pt, Ru, Mn, and Ti, oxide thereof, and mixtures, the carbon filter unit comprises at least one of activated carbon and activated carbon fiber, the activated carbon or activated carbon fiber of the carbon filter unit is formed as one or more layers stacked, a membrane is at a boundary surface of the one or more activated carbon or activated carbon fiber layers, and the membrane is hydrophobic.

10. The multi-layer filtration system of claim 9, further comprising a pre-filter, a HEPA filter, or both.

11. The multi-layer filtration system of claim 9, wherein the hydrophobic membrane is adjacent to the carbon filter unit.

12. The multi-layer filtration system according to claim 1, wherein the mixtures include one or more selected from Fe—Cr—Al, 2MgO-2Al₂O₃-5SiO₂, and CuO—MnO₂.

13. The multi-layer filtration system according to claim 1, wherein the inorganic compound comprises one or more selected from chitosan, N-Halamine, and hydroxyapatite.

14. A filter module comprising the multi-layer filtration system of claim 1.

15. A multi-layer filtration system comprising: a metal catalyst filter unit; a carbon filter unit; and a wet variable filter unit, wherein the metal catalyst filter unit comprises at least one among metals including Ni, Co, Fe, Cu, Cr, Mg, Zn, Ba, Au, Ag, Pd, Pt, Ru, Mn, and Ti, oxides thereof, and mixtures thereof, the carbon filter unit comprises at least one of activated carbon and activated carbon fiber, the wet variable filter unit comprises a wettable member and a sealing member, and the wettable member is a woven or unwoven fabric comprising one or more types of natural and synthetic fibers derived from cotton, rayon, lyocell, polyester, polypropylene, nylon or comprising any mixture thereof, and the sealing member contains water or a liquid mixture containing 70% or more water.

16. The multi-layer filtration system of claim 15, further comprising a pre-filter, a HEPA filter, or both.

17. A filter module comprising the multi-layer filtration system of claim 15.
